(19) United States
(12) Patent Application Publication
(10) Pub. No.: US 2008/0271620 A1
(43) Pub. Date: Nov. 6, 2008

(54) Printing Machine with Modular Additional Printing Group

(75) Inventors: Gunther Hoier, Veitshochheim (DE); Volkmar Schwitzky, Wurzburg (DE); Johannes Schaede, Wurzburg (DE)

Correspondence Address: CROMPTON, SEAGER & TUFTE, LLC, 1221 NICOLLET AVENUE, SUITE 800, MINNEAPOLIS, MN, 55403-2420, US

(73) Assignee: KBA-GIORI S.A., Lausanne (CH)

(21) Appl. No.: 12/089,023

(22) PCT Filed: Oct. 12, 2006
(86) PCT No.: PCT/IB2006/002846

§ 371 Date: Apr. 2, 2008

(30) Foreign Application Priority Data
Oct. 13, 2005 (EP) 05022358.5

(51) Int. Cl. B41F 11/02

(52) U.S. Cl. 101/216

(57) ABSTRACT

There is described a web-fed or sheet-fed printing machine for security papers, in particular banknotes, comprising a machine frame in which is located a main printing group, the printing machine further comprising an additional printing group, independent of the main printing group, placed upstream of the main printing group with respect to a direction of displacement of the web or sheets for performing additional printing of the security papers prior to printing by said main printing group. The additional printing group comprises an inking module containing at least one inking device, and a printing module comprising a cylinder arrangement including a plurality of cylinders, the printing module being interposed between the inking module and the machine frame of the printing machine. The additional printing group is constructed in such a manner that the printing module can be decoupled from the inking module and the machine frame for replacement by another printing module without this requiring removal of said inking module from the printing machine.

### TECHNICAL FIELD OF THE INVENTION

The invention relates to a web-fed or sheet-fed printing machine for security papers, in particular banknotes, comprising inter alia a main printing group and an additional printing group placed upstream of the main printing group with respect to a direction of displacement of the web or sheets for performing additional printing of the security papers prior to printing by the main printing group.

### BACKGROUND OF THE INVENTION

Printing machines are known in the art. European patent application EP 0 132 858 for instance describes an offset printing machine with a main printing group allowing the paper to be printed simultaneously on both sides by offset printing, each side of the paper receiving a complete design with juxtaposed colours. More particularly, the machine is configured so as to be capable of printing the two sides of the paper either according to the conventional offset printing technique or according to another offset printing technique commonly known as “Orlof-offset” printing.

In normal offset printing, in order to print a complete design made up of partial patterns in different colours, each partial pattern is carried by a corresponding printing plate which is mounted on a plate cylinder. Each plate cylinder is inked by an associated inking device in the corresponding colour and the inked patterns of each plate cylinder is then transferred onto a common blanket cylinder to form the complete multicolour design prior to being applied on the paper.

In Orlof-offset printing, chablon cylinders having relief portions (also designated as colour selector cylinders) are inked by the inking devices in the different colours, which colours are then transferred from the chablon cylinders onto a common collecting cylinder (also designated as Orlof cylinder). This Orlof cylinder, which accordingly carries on its surface the inks in the different colours, is used to ink the surface of a single plate cylinder. The multicoloured inked pattern on this printing plate is then transferred to a blanket cylinder for application onto the paper.

The Orlof printing principle is not only used in offset printing, but also in other printing processes, in particular intaglio printing. The main difference between the Orlof printing principle and the normal printing principle resides in the fact that, in the Orlof printing process, a single printing plate is inked with inks of different colours which have previously been collected onto a common ink-collecting surface, thereby ensuring a perfect register between the different colours, the register being guaranteed by the printing plate itself which carries the complete design to be printed. In the normal (i.e. non-Orlof) printing process, the complete design ultimately printed onto the paper is made up of partial designs coming from several printing plates carrying only a portion of the complete design to be printed in one of the colours, which partial designs are assembled on the surface of a blanket prior to printing. In this latter case, the register between the different colours is determined by the preciseness of the transfer of inks from the printing plates onto the surface of the blanket.

The printing machine disclosed in EP 0 132 858 can be configured to operate according to up to four different printing modes, namely (i) printing both sides of the paper according to the Orlof-offset printing process, (ii) printing both sides of the paper according to the normal offset printing process, (iii) printing the recto according to the Orlof-offset printing process and the verso according to the normal offset printing process, and (iv) printing the recto according to the according to the normal offset printing process and the verso according to the Orlof-offset printing process, Switching between any of the four printing modes requires displacement as well as replacement of selected ones of the cylinders within the main printing group of the printing machine, which is a rather complex procedure. Another disadvantage of this solution resides in the fact that the printing configuration of the main printing group of the printing machine is different for each mode and thus requires specific adjustment operations in order to reach a sufficiently satisfying register between the various colours in each printing mode.

Other printing machines equipped with a main printing group for simultaneous recto-verso offset printing using the normal offset printing process, the Orlof-offset printing process or combinations thereof are also disclosed in European patent applications EP 0 343 104, EP 0 343 105, EP 0 343 106 and EP 0 343 107.

A main disadvantage of the above printing machines resides in that the number of printing possibilities, in particular the number of colours available, is always limited by the size of the blanket cylinders and by the bulk of the inking devices. Furthermore, the use of blanket cylinders already in place in the main printing group limits the different printing techniques which could be used for printing other patterns in additional colours.

A solution to this problem has been proposed in European patent application EP 0 949 069 which discloses a machine comprising an additional, independent printing group placed upstream of the main printing group in the feed direction of the paper and allowing a pattern in at least one predetermined colour to be printed over the entire width of the paper before the paper passes into the main printing group of the machine. According to EP 0 949 069, the main printing group and the additional printing group can for instance be designed for offset printing, the additional printing group being placed above the main printing group and consisting of two one-segment plate cylinders inked by respective inking devices, the two plate cylinders contacting a common one-segment blanket cylinder which in turn cooperates with a two-segment impression cylinder disposed in the transport path of the paper, upstream of the main printing group.

The additional printing group disclosed in EP 0 949 069 is an integral part of the printing machine. Associated with the fact that the additional printing group is placed above the main printing group, this renders maintenance operations on the additional printing group (such as replacement of component parts of the additional printing group) quite complicated.

Further, depending on the printing techniques to be implemented by the additional printing group, a specific additional printing group must be mounted on the printing machine. Switching from one printing process to another thus requires replacement of the whole inking and printing part of the additional printing group which task is complex, time consuming and costly.

Printing machines with modular and/or interchangeable configurations are known in the art. Document U.S. Pat. No. 5,697,297 for instance discloses interchangeable printing modules for web printing wherein printing modules operating according to various printing technologies can be installed on a same machine frame. More precisely, an offset printing module comprising a plate cylinder and a blanket cylinder can be installed on the machine frame, which offset printing module cooperates with an inking module. Alternatively a serigraphy printing module, a flexographic printing module or a foil relief printing module can be installed on the same machine frame. According to U.S. Pat. No. 5,697,297, the inking module only cooperates with the offset printing module, this inking module remaining inoperative when using the other printing modules.

U.S. Pat. No. 5,540,149 discloses a web offset rotary printing machine equipped with an interchangeable cassette lodged between the machine frame and an inking module. Depending on the format of the impression to be carried out, or more precisely on the longitudinal length of the impression to be carried out, cassettes with different sizes of plate cylinders can be installed on the machine frame for cooperation with the inking module. The difference between the interchangeable cassettes basically resides in the cylinder sizes of the plate cylinder and blanket cylinder provided in the cassettes as well as in the overall size of the cassettes themselves. As regards the function of these cassettes, all of them fulfil the same purpose, namely performing a printing operation according to conventional offset printing, the only change in printing configuration residing in a change of printing format. Furthermore, while a “same” inking module is used for cooperation with all cassettes, adaptations are required in order to make this inking module work together with the selected cassette. In particular, this implies a more complex design of the inking module whereby the position of the inking rollers contacting the plate cylinder in the cassette is changed. The varying size of the cassettes moreover implies that the contact point between the blanket cylinder in the cassette and the impression cylinder in the machine frame changes from one cassette to another, thereby implying completely new printing settings from one configuration to another. A solution with similar drawbacks is disclosed in U.S. Pat. No. 4,616,564.

U.S. Pat. No. 4,462,311 discloses a web offset rotary printing machine wherein two configurations of intermediate printing modules can be interposed between an inking module and a machine frame of the printing machine. Similarly to U.S. Pat. Nos. 5,540,149 and 4,616,564, both printing modules are designed to operate according to the same printing process, i.e. for conventional offset printing, the only difference residing in the size of the plate cylinder and blanket cylinder. According to U.S. Pat. No. 4,462,311, while both intermediate modules cooperate with basically the same configuration of inking modules, the position of the impression cylinder in the machine frame has to be adapted from one intermediate module to the other. This implies a more complex mounting of the impression cylinder in the machine frame whereby the position of the impression cylinder is allowed to be changed.

U.S. Pat. No. 5,136,942 discloses a web-fed printing machine for recto-verso printing of both sides of a web which is designed in such a manner that a format of impression can be changed, i.e. by allowing the blanket cylinder and plate cylinder to be replaced by cylinders of different diameters. In this case again, the inking module configuration has to be adapted to the size of the plate cylinders to be inked, this implying an adaptation of the position of the inking rollers of the inking module which cooperate with the plate cylinder. In any case, the printing machine is only adapted to perform a printing operation according to a single printing process, i.e. for conventional offset printing.

There therefore remains a need for a printing machine the configuration of which can be easily changed, especially for printing according to a first printing process or at least a second, different, printing process.

### SUMMARY OF THE INVENTION

Accordingly, a general aim of the invention is to improve the known machines of the type comprising an additional printing group placed upstream of a main printing group.

More specifically, an aim of the invention is to improve the ability of the operator to perform maintenance operations on the additional printing group, including but not exclusively the replacement of component parts of the additional printing group.

Another aim of the invention is to improve the flexibility of the printing machine by simplifying the operations that would be required in order to switch the additional printing group from one configuration to another.

Still another aim of the invention is to propose a solution wherein the additional printing group can be easily and quickly modified to perform any of at least two different printing configurations.

These aims are achieved thanks to a printing machine with an additional printing group having the features listed in the independent claim, namely a printing machine equipped with an additional printing group comprising an inking module containing at least one inking device and a printing module comprising a cylinder arrangement including a plurality of cylinders, the printing module being interposed between the inking module and a machine frame of the printing machine. According to the invention, the additional printing group is constructed in such a manner that the printing module can be decoupled from the inking module and the machine frame for replacement by another printing module without this requiring removal of the inking module from the printing machine. The additional printing group is furthermore constructed in such a manner that at least a first printing module with a first cylinder arrangement or a second printing module with a second cylinder arrangement, different from the first cylinder arrangement, is installable between the inking module and the machine frame without this requiring constructional changes or adaptations to the inking module and to the machine frame. The printing module is preferably constructed as an independent self-supporting unit capable of being coupled to or decoupled from the inking module and the machine frame.

With such a configuration, the additional printing group can be easily and quickly changed from a first printing configuration (such as for offset printing) to a second printing configuration (such as for Orlof-offset printing).

Also claimed is a printing module adapted to form part of the additional printing group of the above printing machine as well as an assortment of printing modules comprising at least a first printing module with a first cylinder arrangement and at least a second printing module with a second cylinder arrangement different from the first, wherein the first and second printing modules are adapted to cooperate with the same inking module and the same machine frame of the printing machine.

Within the scope of the present application, it shall be understood that the claimed printing module and claimed assortment of modules refer to a printing module or a set of printing modules each adapted for cooperation with the same inking module and the same machine frame of a printing machine, i.e. without this requiring any change or adaptation to the elements of the printing machine with which the printing modules are designed to cooperate. The features of the claimed printing module and assortment of modules are thus necessarily related to and dependent on the configuration of the machine with which this assortment is designed to operate. This further implies that the claimed printing module and assortment of printing modules and the claimed printing machine are inter-related products.

According to the invention, the printing module of the additional printing group thus forms an independent printing module which can be easily and quickly replaced without this requiring removal of the inking module, thereby also reducing costs. Further, the additional printing group can quickly be changed from one printing configuration to another using a specific assortment of printing modules that are adapted to cooperate with the same inking module and the same machine frame of the printing machine, thereby providing a great flexibility for the operator to choose between various printing techniques to print the security papers. With this solution, a printing machine with its main printing group can be adapted to various needs by changing only key and necessary parts of the additional printing group.

Other advantageous embodiments are the subject-matter of the dependent claims.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 represents a first embodiment of a sheet-fed printing machine according to the invention comprising an additional printing group for offset printing associated with a conventional main printing group for performing simultaneous recto-verso offset printing of the sheets;

FIG. 2 represents a second embodiment of a sheet-fed printing machine according to the invention comprising an additional printing group designed for Orlof-offset printing associated with the same main printing group as in FIG. 1; and

FIG. 3 represents an alternative configuration of the second embodiment of FIG. 2 comprising an additional printing group also designed for Orlof-offset printing but having a different cylinder arrangement than that of the printing group of FIG. 2.

### DESCRIPTION OF THE INVENTION

The invention will be described hereinafter in the context of a sheet-fed offset printing machine for printing security papers, in particular banknotes. As this will be apparent from the following, the various embodiments illustrated in the drawings are based on a common machine configuration with the same main printing group adapted for simultaneous recto-verso offset printing of the sheets. This main printing group is as such similar to that described in European patent application EP 0 949 069 which is incorporated herein by reference. It will however be understood that the main printing group could be adapted for performing printing according to other printing processes, such as intaglio printing. Similarly, the printing machine could perfectly be adapted for performing printing onto a web rather than individual sheets.

The printing machine comprises an additional printing group, independent of the main printing group, placed upstream of the main printing group with respect to a direction of displacement of the sheets, this additional printing group performing additional printing of the security papers prior to printing by the main printing group. According to the invention, this additional printing group comprises two independent and complementary modules, namely an inking module (designated in the Figures by reference numeral 1) and a printing module (designated in the Figures by reference numerals 2, 2′ and 2″).

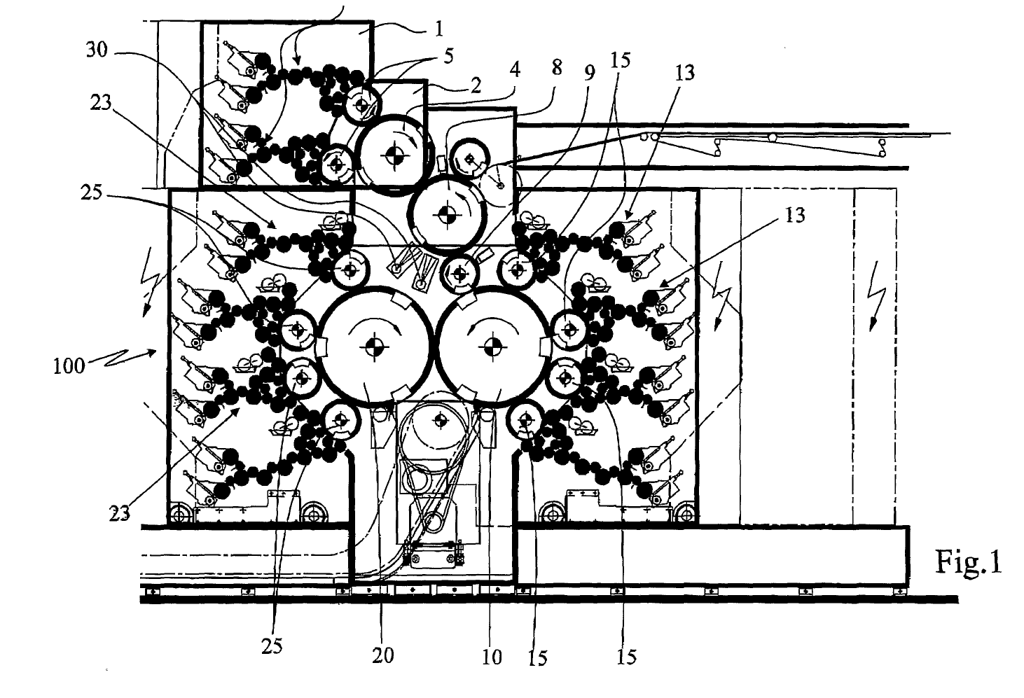

The inking module 1 comprises at least one inking device 3, as such known in the art, which fulfils the function of ink supply and transfer to the downstream-located printing module 2, 2′, 2″. In the illustrated embodiments, the same inking module 1 is used in each configuration and comprises two separate inking devices 3 each conventionally including an arrangement of a pair of ink fountains coupled to an inking train consisting of a plurality of inking rollers for ensuring the appropriate distribution and transfer of ink to the printing module 2, 2′, 2″. In that respect, the inking devices 3 of the inking module 1 are similar to the inking devices (designated by references 13, 23 in the Figures) used in the main printing group. It will be understood that, within the scope of the invention, the configuration of the inking module 1 could however depart from the specific illustrations of FIGS. 1 to 3.

The inking module 1 and printing module 2, 2′, 2″ are mounted on the machine frame (100 in the Figures) of a same printing machine where the main printing group is located. Both modules are independent, which means that they each represent a physical autonomous entity or unit, mainly comprising a plurality of cylinders or rollers firmly fixed together in separate frames that can be coupled to each other and on the machine frame of the printing machine. Both modules are preferably constructed so as to be capable of being moved independently for coupling to or decoupling from each other and from the machine frame of the printing machine.

In the first embodiment of FIG. 1, the printing module, designated by reference numeral 2, is designed for offset printing and comprises a blanket, cylinder 4 associated with two plate cylinders 5 in contact with the two inking devices 3 of the inking module 1. The blanket cylinder 4 is disposed at the coupling section with the machine frame 100 and contacts an impression cylinder 8 located within the machine frame 100. When coupled together and to the machine frame 100, these two modules 1, 2 form, with the impression cylinder 8, the additional independent printing group which is placed upstream of the main printing group of the printing machine.

The main printing group, which is adapted in this case to perform simultaneous recto-verso offset printing of the sheets, comprises in a conventional manner two blanket cylinders 10, 20 rotating in the direction indicated by the arrows and between which the paper passes to receive the multicoloured impressions. In this example, blanket cylinders 10, 20 are three-segment cylinders, i.e. cylinder having a peripheral length approximately three times that of the printing length on the sheets. The blanket cylinders 10, 20 receive the different patterns in their respective colours from plate cylinders 15 and 25 (four on each side) which are distributed around the circumference of the blanket cylinders 10, 20. These plate cylinders 15 and 25, which each carry a corresponding printing plate, are themselves inked by corresponding inking devices 13 and 23, respectively, in a manner known in the art. The two groups of inking devices 13 and 23 are advantageously placed in two inking carriages that can be moved toward or away from the centrally-located plate cylinders 15, 25 and blanket cylinders 10, 20.

Sheets are fed from a feeding station (not illustrated in the Figures) located at the right-hand side of the main printing group onto a feeding table and then onto the impression cylinder 8 which cooperates with the blanket cylinder 4 of the printing module 2 where the sheets first receive the impression from the additional printing group. The impression cylinder 8 is in this example a two-segment cylinder which can transport two successive sheets on its periphery. Once printed at the printing nip between cylinders 4 and 8, the sheets are transported by the impression cylinder 8 in front of a drying device 30 where the freshly printed ink is dried prior to being fed to the main printing group. The sheets are then transferred from the impression cylinder 8, via a transfer cylinder 9, onto the blanket cylinder 10 of the main printing group. The sheets are then carried by the blanket cylinder 10 to the printing nip between blanket cylinders 10 and 20 where they receive the recto-verso impression from the main printing group. Once printed by the main printing group, the sheets are transferred to a sheet transport system which carries the sheets to sheet delivery piles (not illustrated in the Figures) located at the left-hand side of the main printing group.

The additional printing group is placed upstream of the blanket cylinders 10, in the direction of displacement of the sheets in the machine. As mentioned, the additional printing group illustrated in the example of FIG. 1 is designed for offset printing. It is operatively linked to the main part of the printing machine thanks to a contact between the blanket cylinder 4 and the impression cylinder 8. The plate cylinders 5 which each carry a printing plate with the appropriate partial printing patterns to be printed in the corresponding colours are inked by the rollers of the inking devices 3. The inked patterns of the plate cylinders 5 are then transferred in register onto the blanket cylinder 4 of the independent printing module 2 to form the complete multicolour image to be printed on the sheets, and this complete image is transferred to the paper at the printing nip between the blanket cylinder 4 and the impression cylinder 8.

In the embodiment of FIG. 1, the blanket cylinder 4 is preferably a two-segment cylinder (i.e. a cylinder carrying two blankets) while the plate cylinders 5 are one-segment cylinder (i.e. cylinders carrying only one printing plate each). The advantage of using a two-segment blanket cylinder 4 in this embodiment will become apparent from reading the description of the other embodiments.

As already mentioned, before passing between the two blanket cylinders 10, of the main printing group, the sheets also pass in front of the drying device 30 comprising, for example, ultraviolet radiation lamps which are placed around the impression cylinder 8. This device 30 allows the drying of the freshly printed ink prior to feeding of the sheets to the main printing group so as to prevent mixing with the inks subsequently applied by the main printing group.

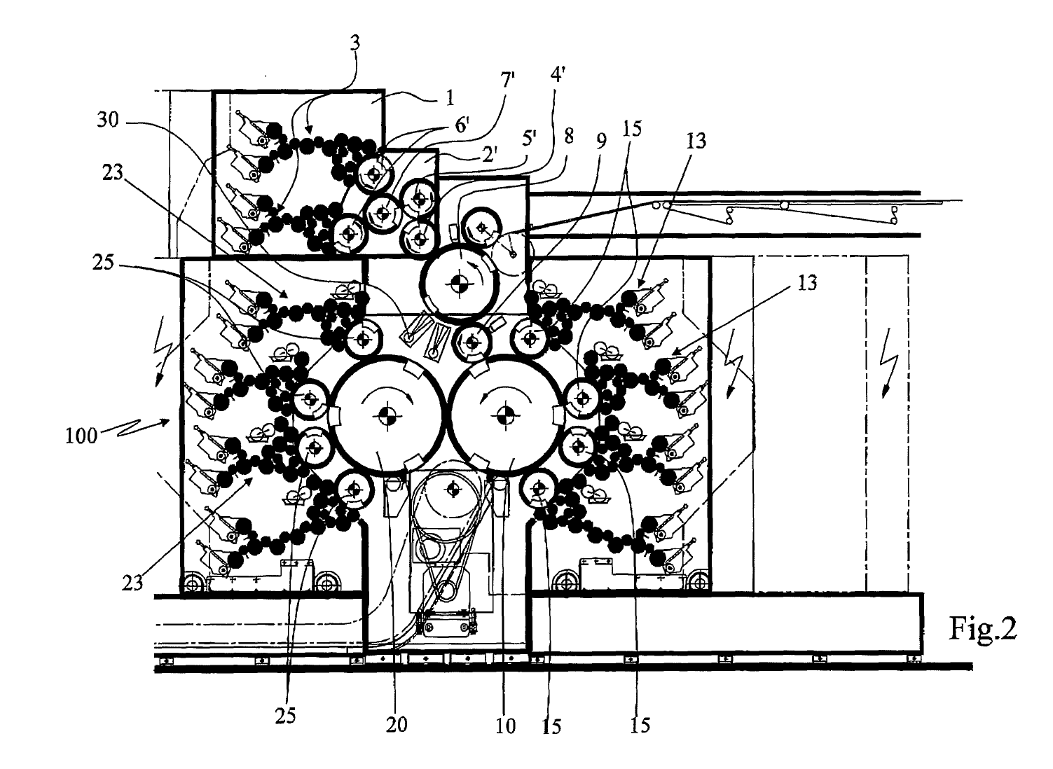

FIG. 2 illustrates a second embodiment of the printing machine which shares the same main configuration as that of FIG. 1, namely the same main printing group with its two blanket cylinders 10, 20 and associated plate cylinders 15, 25 and inking devices 13, 23, as well as the same sheet transport system with its sheet feeding system, impression cylinder 8, transfer cylinder 9 and sheet delivery system.

The only difference between the embodiment of FIG. 1 and that of FIG. 2 resides in the specific configuration of the additional printing group, or more precisely of the printing module, designated in this example by reference numeral 2′ for the sake of distinction. In this embodiment, the inking module 1 remains unchanged with its two inking devices 3. The printing module 2′, on the other hand, comprises in this case two chablon cylinders 6′ (or colour selector cylinders), inked by the inking devices 3, one collecting cylinder 7′ (also designated as an Orlof collecting cylinder), a single plate cylinder 5′ and a blanket cylinder 4′, all cylinders being one-segment cylinders, i.e. cylinders having a diameter approximately half that of the impression cylinder 8 and a third of the diameter of the blanket cylinders 10, 20. In the illustrated configuration, the printing module 2′ forms an autonomous entity for performing printing according to the Orlof-offset technique. In this configuration, the Orlof collecting cylinder 7′ cooperates with the two chablon cylinders 6′ which are provided with relief areas corresponding to the contour of the areas to be inked in the corresponding colour on the plate cylinder 5′. The Orlof collecting cylinder 7′ collects the ink patterns in the various colours supplied by the chablon cylinders and transfer these patterns onto the surface of the plate cylinder 5′ which carries a single printing plate representing the complete image to be printed on the sheets. This image is finally transferred from the plate cylinder 5′ to the blanket cylinder 4′ for application onto the sheets. In contrast to the embodiment of FIG. 1 where the register between the various ink patterns is determined by the preciseness of the transfer of the ink from the plate cylinders 5 to the blanket cylinder 4, the register is ensured, in the embodiment of FIG. 2, by the single plate cylinder 5′ which is inked in the various colours collected by the Orlof collecting cylinder 7′. With the embodiment of FIG. 2, one can achieve absolutely precise register between patterns of different colours as there is only one plate cylinder 5′ which is inked in the various colours. This Orlof principle is thus particularly useful in case one desires to print multicolour patterns composed mainly of fine linear structures, such as guilloches or similar line patterns.

The printing modules 2 and 2′ used in the embodiments of FIGS. 1 and 2 are advantageously designed in such a way as to exhibit identical external dimensions, thereby allowing the inking module 1 to be disposed in exactly the same position relative to the main part of the machine. This is ensured by using a two-segment blanket cylinder 4 in the printing module 2 of FIG. 1 so that there exists sufficient space to accommodate the Orlof collecting cylinder 7′, the plate cylinder 5′ and the blanket cylinder 4′ in the printing module 2′ of FIG. 2. As compared to the prior art solution, it shall be understood that replacement of the printing module 2 by printing module 2′, or vice versa, does not as such have as purpose to merely adapt the configuration of the machine to different impression formats. Rather, the replacement of one printing module with the other enables to change the printing processes according to which the additional printing group is operating (namely according to offset printing or Orlof-offset printing in this specific example).

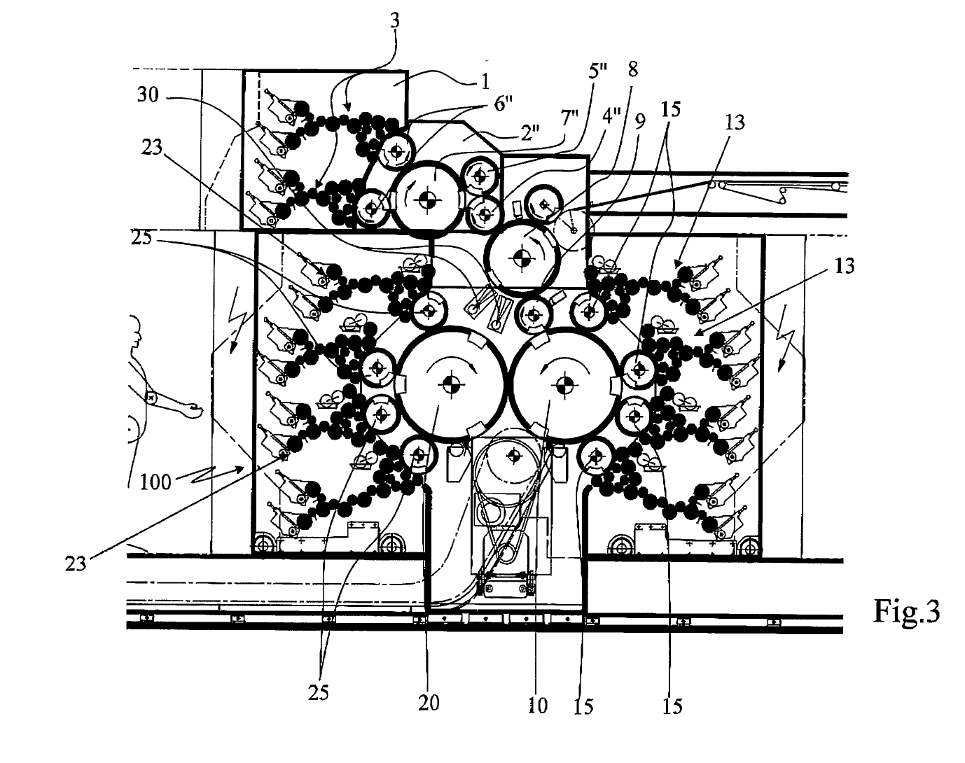

FIG. 3 represents an alternative configuration of the above second embodiment with a different printing module designated by reference numeral 2″, again for the sake of distinction. In FIG. 3, the printing module 2″ is also designed for printing according to the Orlof-offset printing technique and comprises a pair of chablon cylinder 6″, an Orlof collecting cylinder 7″, a single plate cylinder 5′ and a blanket cylinder 4″ operating in the same way as for the embodiment of FIG. 2. This third embodiment differs from the previously described embodiment mainly in that the Orlof collecting cylinder 7″ is a two-segment cylinder, i.e. a cylinder having a diameter approximately twice that of the Orlof collecting cylinder 7′ of FIG. 2. This configuration provides more space around the surface of the collecting cylinder 7″, allowing the optional use of additional inking devices, if necessary. This solution for instance allows the use of an additional inking device which would be placed in contact with the upper surface of the Orlof collecting cylinder 7″ in the area between the second chablon cylinder 6″ and the plate cylinder 5″. This solution also provides a better access to the collecting cylinder 7″ itself for maintenance purposes. In this alternative solution, the inking module 1 is moved backward relative to the main printing group because of the greater space required by the two-segment Orlof collecting cylinder 7″.

One will understand that the three embodiments illustrated in FIGS. 1 to 3 share a substantial amount of identical parts, the only difference between these embodiments residing in the specific configuration of the printing modules 2, 2′, 2″ interposed between the inking module 1 and the machine frame 100 of the printing machine. Accordingly, in order to switch from one configuration to another, one merely has to replace the printing module by another one without this requiring any constructional changes to any other part of the machine. In particular, the same inking module 1 is can be used for all three embodiments and no changes or adaptations of the rest of the machine are required. With relatively little effort and time, it is thus possible to configure the additional printing group of the printing machine for various printing processes.

One will also understand that each of the printing modules 2, 2′, 2″ needs to follow certain design rules in order to be able to couple any of these to the same machine frame 100, as well as to the same inking module 1. As far as the coupling between the printing modules 2, 2′, 2″ and the machine frame 100 is concerned (or more precisely the coupling between the printing modules 2, 2′, 2″ and the impression cylinder 8), each of the printing modules 2, 2′, 2″ should be configured in such a way that the contacting point (i.e. the printing nip) between the blanket cylinder 4, 4′, 4″ and the impression cylinder 8 remains the same in each case. This means that the location of the blanket cylinder 4, 4′, 4″ with respect to the impression cylinder 8 is determined. In FIGS. 1 to 3, this first condition is satisfied by disposing the blanket cylinders 4, 4′, 4″ on a same line passing by the axis of rotation of the impression cylinder 8, the actual position of the blanket cylinder on the said line depending on the diameter of the blanket cylinder 4, 4′, 4″. Printing modules exhibiting different contacting locations with the impression cylinders 8 might be envisaged, but a disadvantage thereof would reside in different printing behaviours. It is greatly preferred to ensure that the printing nip remains the same among all configurations.

As far as the coupling between the printing modules 2, 2′, 2″ and the inking module 1 is concerned, the cylinders of the printing modules which are in contact with the inking devices 3 (which cylinders could be defined as “input cylinders”), namely plate cylinders 5 in FIG. 1 and chablon cylinders 6′ and 6″ in FIGS. 2 and 3, must be of similar dimensions and be positioned at the same locations with respect to the inking module 1 (in the coupled state). This second condition is satisfied in FIGS. 1 to 3 by ensuring that the plate cylinders 5 in FIG. 1 and the chablon cylinders 6′, 6″ in FIGS. 2 and 3 have the same diameter and are positioned at the same locations with respect to the coupling section of the printing modules 2, 2′, 2″ with the inking module 1.

One will also understand that the side panels of each printing modules 2, 2′, 2″ will be designed in a same way so as to fit between the side panels of the inking module 1 and of the machine frame 100.

In order to facilitate replacement operations, each printing module 2, 2′, 2″ is preferably designed as an independent self-supporting unit capable of being coupled to or decoupled from the inking module 1 and the machine frame 100 of the printing machine. Such replacement operations can further be facilitated by designing the inking module 1 as a mobile inking carriage so that it can be moved toward or away from the printing module 2, 2′, 2″, Such a mobile configuration also allows easy adaptation of the position of the inking module 1 on the machine in dependence of the actual dimensions of the printing module which is interposed between the inking module 1 and the machine frame.

In summary, the additional printing group of each of the above-described embodiments of the printing machine is constructed in such a manner that the printing module 2, 2′ or 2″ can be decoupled from the inking module 1 and the machine frame 100 for replacement by another printing module, without this requiring removal of the inking module 1. Further, the additional printing group is advantageously constructed so that at least a first printing module with a first cylinder arrangement or a second printing module with a second cylinder arrangement, different from the first cylinder arrangement, is installable between the inking module and the machine frame, without this requiring constructional changes to the inking module 1 and the machine frame 100.

It will be appreciated that various modifications and/or improvements might be made to the above-described embodiments without departing from the scope of the claims as annexed. In particular, as already mentioned, the printing machine can be designed for printing onto individual sheets or onto webs. Similarly, the main printing group of the printing machine could be designed to perform printing according to any suitable printing process, including offset printing, intaglio printing or any other suitable printing processes or combination thereof. This also applies to the printing operation performed by the additional printing group.

As a matter of fact, the inking module of the additional printing group could adopt a different inking system than that illustrated in the Figures. For instance, rather than using ink fountains and inking trains, the inking module could for instance use ink spraying devices, inking chambers of the type comprising so-called anilox rollers or any other suitable inking system.

1. A web-fed or sheet-fed printing machine for security papers, in particular banknotes, comprising a machine frame in which is located a main printing group, the printing machine further comprising an additional printing group, independent of the main printing group, placed upstream of the main printing group with respect to a direction of displacement of the web or sheets for performing additional printing of the security papers prior to printing by the main printing group,
wherein the additional printing group comprises:
an inking module containing at least one inking device, and
a printing module comprising a cylinder arrangement including a plurality of cylinders, the printing module being interposed between the inking module and the machine frame of the printing machine,
the additional printing group being constructed in such a manner that the printing module can be decoupled from the inking module and the machine frame for replacement by another printing module, without this requiring removal of said inking module (1) from the printing machine,
the additional printing group being further constructed in such a manner that at least a first printing module with a first cylinder arrangement or a second printing module with a second cylinder arrangement, different from the first cylinder arrangement, is installable between the inking module and the machine frame without this requiring constructional changes or adaptations to the inking module and to the machine frame.

2. The printing machine according to claim 1, wherein the printing module is constructed as an independent self-supporting unit capable of being coupled to or decoupled from the inking module and the machine frame.

3. The printing machine according to claim 1, wherein each one of the first and second printing modules includes a blanket cylinder placed at a coupling section between the printing module and the machine frame, the blanket cylinder contacting an impression cylinder located in said machine frame, the first and second printing modules being constructed in such a manner that a contacting point between the impression cylinder and the blanket cylinder is the same for each one of the first and second printing modules.

4. The printing machine according to claim 1, wherein each one of the first and second printing modules includes at least one input cylinder placed at a coupling section between the printing module and the inking module, the input cylinder contacting the inking module, the first and second printing modules being constructed in such a manner that a location of the input cylinder with respect to the inking module, when the inking module is operatively coupled to the printing module, is the same for each one of the first and second printing modules.

5. The printing machine according to claim 1, wherein the additional printing group is adapted for performing printing of the security papers according to offset printing or Orlof-offset printing.

6. The printing machine according to claim 5, wherein the additional printing group is designed for offset printing and wherein the printing module comprises a cylinder arrangement including at least one plate cylinder inked by the inking module, and a blanket cylinder contacting the plate cylinder and the security papers to be printed for transferring ink applied on the plate cylinder onto the security papers.

7. The printing machine according to claim 6, wherein the blanket cylinder and the at least one plate cylinder are respectively a two-segment cylinder and a one-segment cylinder.

8. The printing machine according to claim 5, wherein the additional printing group is designed for Orlof-offset printing and wherein the printing module comprises a cylinder arrangement including at least two chablon cylinders inked by the inking module with at least two different inks, an Orlof collecting cylinder contacting the chablon cylinders for collecting the different inks supplied by the chablon cylinders, a single plate cylinder contacting the Orlof collecting cylinder in order to be inked with the different inks collected by the Orlof collecting cylinder, and a blanket cylinder contacting the plate cylinder and the security papers to be printed for transferring the different inks applied on the plate cylinder onto the security papers.

9. The printing machine according to claim 8, wherein the chablon cylinders, the plate cylinder and the blanket cylinder are one-segment cylinders, while the Orlof collecting cylinder is a two-segment or one-segment cylinder.

10. The printing machine according to claim 1, wherein the additional printing group is located above the main printing group.

11. The printing machine according to claim 1, the inking module is constructed as a mobile carriage capable of moving towards and away from the printing module.

12. A printing module for printing security papers, in particular banknotes, the printing module comprising a cylinder arrangement including a plurality of cylinders, the printing module being adapted to form part of an additional printing group of a printing machine as defined in claim 1, the printing module being adapted to be coupled to or decoupled from the inking module and the machine frame of the printing machine.

13. An assortment of printing modules as defined in claim 12, the assortment including a first printing module with a first cylinder arrangement and at least a second printing module with a second cylinder arrangement different from the first cylinder arrangement, wherein the first and second printing modules are adapted to cooperate with the same inking module and the same machine frame of the printing machine.

14. The assortment of printing module modules according to claim 13, wherein each one of the first and second printing modules includes a blanket cylinder placed at a coupling section of the printing module with the machine frame, the first and second printing modules being constructed in such a manner that a contacting point between the blanket cylinder and an impression cylinder located in the machine frame is the same for each one of the first and second printing modules.

15. The assortment of printing modules according to claim 13, wherein each one of the first and second printing modules includes at least one input cylinder placed at a coupling section of the printing module with the inking module (1), the first and second printing modules being constructed in such a manner that a location of the input cylinder with respect to the inking module, when the printing module is operatively coupled to the inking module, is the same for each one of the first and second printing modules.
